(19) United States
(12) Patent Application Publication
(10) Pub. No.: US 2008/0177881 A1
(43) Pub. Date: Jul. 24, 2008

(54) System and Method for Applying Quality of Service (QoS) in iSCSI Through ISNS

(75) Inventors: Eric Endebrock, Round Rock, TX (US); Matthew W. Baker, Austin, TX (US); Drue Reeves, Round Rock, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/625,179

(22) Filed: Jan. 19, 2007

(51) Int. Cl. G06F 15/16

(52) U.S. Cl. 709/227

(57) ABSTRACT

A method for applying quality of service in a storage network comprises registering a target with a server, and setting a quality of service priority for the target on the server, on the target, or on both the server and the target. An initiator registers with the server, and the initiator utilizes the quality of service priority to send data to the target.

### FIELD OF THE DISCLOSURE

This disclosure relates generally to information handling systems, and relates more particularly to the method and system for applying quality of service in iSCSI through iSNS.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Internet Small Computer System Interface (iSCSI) is a storage technology that facilitates the transport of Small Computer Interface (SCSI) commands and data over TCP/IP networks. As iSCSI grows in importance and is implemented more widely to solve unique problems that information technology (IT) administrators face today, a number of specific challenges emerge. One such challenge is ensuring the appropriate quality of service for iSCSI datagrams. An example, bootstrapping of hosts (initiators) utilizing network based iSCSI storage targets, is growing in popularity. However, one must be able to provide predictable and prioritized connectivity between initiator and target to ensure reliable operations. Fortunately, many quality of service (QoS) solutions exist today to solve this problem using a variety of techniques, e.g. IP based differentiated service code points (DSCP) (RFC2474) or Ethernet based 802.1Q/p priority tagging.

While these QoS techniques may exist today, the configuration of these techniques is complex, manual, and difficult to manage. Moreover, QoS policies are many times implemented in an “all-or-nothing” fashion where QoS policy is applied with little precision. For example, network tuples are granted a certain priority level, or all iSCSI traffic is prioritized at a certain level. These ‘all or nothing’ techniques, many times, blunt the effectiveness of QoS implementations.

Internet Storage Name Service (iSNS) is the centralized discovery service for iSCSI, facilitating automated discovery, management, and configuration of iSCSI devices, iSNS, most importantly, provides a mechanism for automating the discovery and logon process for iSCSI initiators. While iSCSI initiators and targets use iSNS for discovery and limited configuration, the protocol lacks a broader set of management parameters and extensibility, including QoS class of service control for the administrator to centrally manage and control an iSCSI QoS policy.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a schematic view of an information storage network;

FIG. 2 is a schematic view of a discovery domain on an information storage network with an initiator and a target;

FIG. 3 is a schematic view of a discovery domain on an information storage network with an initiator and multiple targets;

FIG. 4 is a schematic view of an information storage network having an initiator with multiple discovery domains;

FIG. 5 is a schematic view of an information storage network having multiple initiators and multiple discovery domains; and

FIG. 6 is a flow diagram of a method for applying quality of service in iSCSI through iSNS.

The use of the same reference symbols in different drawings indicates similar or identical items.

### DETAILED DESCRIPTION

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

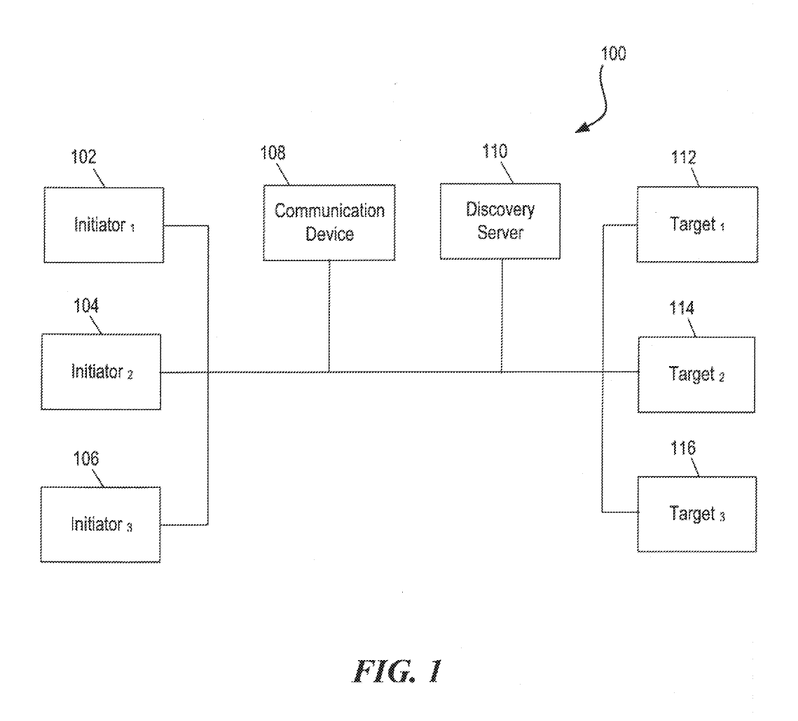

FIG. 1 shows a block diagram of an exemplary embodiment of an information storage network 100 comprising a first initiator 102, a second initiator 104, a third initiator 106, a communication device 108, a discovery server 110, a first target 112, a second target 114, and a third target 116. In different embodiments any number of initiators may access any number of targets within the information storage network 100. In an embodiment the first initiator 102, the second initiator 104, and the third initiator 106 send data streams over the information storage network 100 to be stored on the first target 112, the second target 114, and the third target 116.

In an exemplary embodiment the first initiator 102, the second initiator 104, and the third initiator 106 are Internet Small Computer System Interface (iSCSI) devices or any similar devices that a person of ordinary skill in the art would recognize as equivalent devices. Also, the first target 112, the second target 114, and the third target 116 are iSCSI devices, such as hard disks for storage, or any similar devices that a person of ordinary skill in the art would recognize as equivalent devices. In different embodiments the discovery server 110 is an Internet Storage Name Service (iSNS) server, a named management server, or any similar device that a person of ordinary skill in the art would recognize as an equivalent device. In one embodiment of the information storage network 100, there is an iSNS server, and two or more iSCSI devices (initiators and targets), where the iSNS server allows the iSCSI devices to locate and to set up a connection between them so they can communicate.

In an embodiment when the information storage network 100 is first created, an administrator sets the priority for the first target 112, the second target 114, and the third target 116. By setting the priority for the first target 112, the second target 114, and the third target 116, when data streams are sent over the information storage network 100, it is possible to ensure that certain data streams pass through the information storage network ahead of other data streams. Next, the first target 112, the second target 114, and the third target 116 register with the discovery server 110 and send certain information to the policy engine (not shown) of the discovery server. In an exemplary embodiment the information sent by the first target 112, the second target 114, and the third target 116 is priority information, such as quality of service (QoS), and the location of each target on the information storage network 100. The first initiator 102, the second initiator 104, and the third initiator 106 use the priority information to control the order that data streams are sent across the information storage network 100.

In an exemplary embodiment the first initiator 102, the second initiator 104, and the third initiator 106 use the communication device 108 to register with and request target information from the discovery server 110. In one embodiment the communication device 108 is a Dynamic Host Configuration Protocol (DHCP) server, computer, router, or any similar device that a person of ordinary skill in the art would recognize as an equivalent device. A DHCP device allows the first initiator 102, the second initiator 104, and the third initiator 106 to obtain an Internet Protocol (IP) address from the discovery server 110 and to obtain the IP address of the discovery server. Then the first initiator 102, the second initiator 104, and the third initiator 106 receive priority information, such as quality of service (QoS), about the first target 112, the second target 114, and the third target 116 from the policy engine (not shown) of the discovery server 110. In an embodiment the priority information for the first target 112, the second target 114, and the third target 116 is set on the targets themselves, or an administrator sets the priority information for all of the targets directly into the policy engine of the discovery server 110. This priority information may help the first initiator 102, the second initiator 104, and the third initiator 106 send data over the information storage network 100 in such a way to ensure that the data is received at the first target 112, the second target 114, and the third target 116.

In an exemplary embodiment the information storage network 100 may have one or multiple discovery domains located within it. A discovery domain may comprise an initiator and a target or targets that the initiator will be able to communicate with over the information storage network 100. In different embodiments an initiator may only have one target in its discovery domain or the initiator may have multiple targets in a discovery domain with which to communicate. Also, in another exemplary embodiment an initiator has multiple discovery domains with multiple targets on the information storage network 100.

In an embodiment the first initiator 102, the second initiator 104, and the third initiator 106 will send more data streams than the information storage network 100 can process at the same time. These data streams are sent to either the first target 112, the second target 114, or the third target 116 and depending on which target the data stream is sent to, there will be different needs to ensure the speed and reliability of the data streams to reach either the first target, the second target, or the third target. In such a situation the first initiator 102, the second initiator 104, and the third initiator 106 utilize the priority information to assign priority bits in the headers of the data streams sent through the information storage network 100. The first initiator 102, the second initiator 104, and the third initiator 106 leverage quality of service attributes (the priority information) so that the most important data streams pass through the information storage network 100 before the other data streams.

In an exemplary embodiment there are multiple quality of service methods or techniques to set the priority of the data streams, such as Layer 3 DSCP, Layer 2 802.1 Q/p priority tagging or another type that a person of ordinary skill in the art would recognize as an equivalent method or technique. When the information storage network 100 processes the data streams sent to the first target 112, the second target 114, and the third target 116, the information storage network looks at the priority bits (set by the first initiator 102, the second initiator 104, and the third initiator 106) of the data streams to determine which data streams to send and which data to queue. In one embodiment, where the first initiator 102, the second initiator 104, and the third initiator 106 utilize and leverage the priority information quality of service set for the targets, the information storage network 100 facilitates very fine-grained policies, applying quality of service on a number of levels.

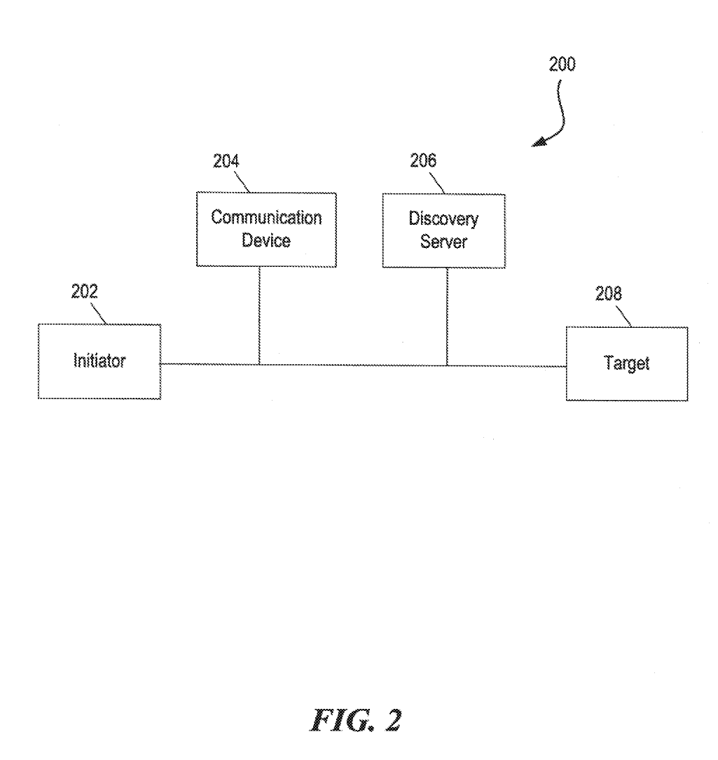

FIG. 2 shows a block diagram of an exemplary embodiment of a discovery domain 200 comprising an initiator 202, a communication device 204, a discovery server 206, and a target 208. The discovery domain 200 is an exemplary embodiment of a discovery domain in the information storage network 100, where the initiator 202 only has access to store data on the target 208. In an embodiment the initiator 202 uses the communication device 204 to register with and request target information from the discovery server 206. The initiator 202 receives priority information, such as quality of service (QoS), about the target 208 from the policy engine (not shown) of the discovery server 206. This priority information helps the initiator 202 send data over the information storage network 100 in such a way that the initiator ensures that the data is received at the target 208.

In one embodiment discovery domain 200 is the only discovery domain on the information storage network 100. In an exemplary embodiment the initiator 202 can send too many data streams for the information storage network 100 to process at the same time. In such a situation, the initiator 202 leverages or sets priority bits in the headers of the data streams sent through the information storage network 100, allowing the most important data streams to pass through the information storage network first. In another embodiment the discovery domain 200 is one of several discovery domains on the information storage network 100, whereby the priority of the data streams sent by the initiator 202 is compared with other data stream priorities from other initiators in the information storage network 100. When the information storage network 100 processes the data streams sent to the target 208, the information storage network looks at the priority bits (set by the initiator 202) of the data streams to determine which data streams to send and which data to queue in the information storage network before being sent from the information storage network.

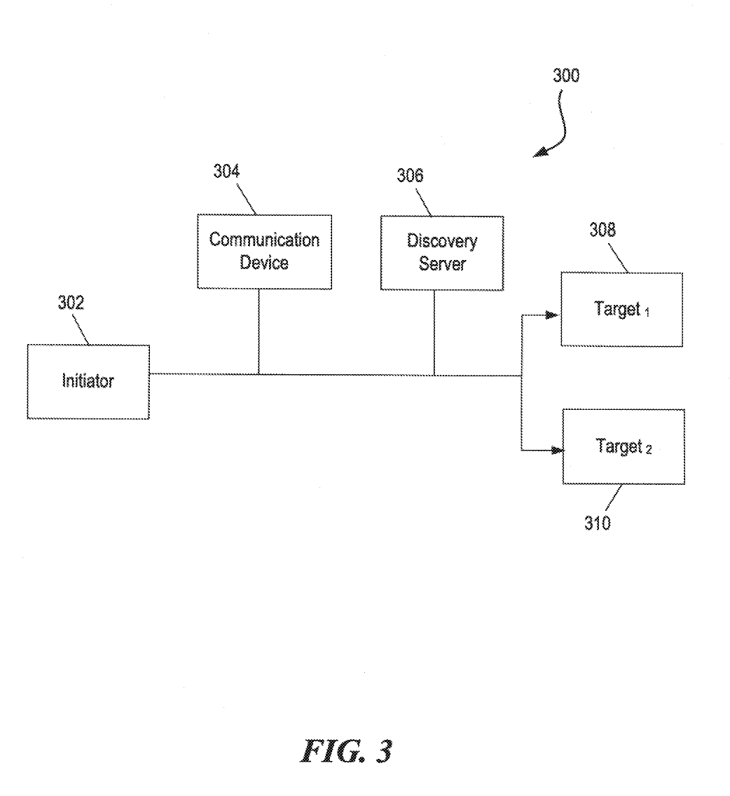

FIG. 3 shows a block diagram of an exemplary embodiment of a discovery domain 300 comprising an initiator 302, a communication device 304, a discovery server 306, a first target 308, and a second target 310. The discovery domain 300 is an exemplary embodiment of a discovery domain in the information storage network 100, where the initiator 302 has the ability to communicate with and save data on both the first target 308 and the second target 310. In an embodiment the initiator 302 uses the communication device 304 to register with and request target information from the discovery server 306. Then the initiator 302 receives priority information, such as QoS, about the first target 308 and the second target 310 from the policy engine (not shown) of the discovery server 306. In one embodiment the priority information for the first target 308 and the second target 310 is set on the targets themselves, or an administrator sets the priority information for both targets directly into the policy engine of the discovery server 306. This priority information helps the initiator 302 send data over the information storage network 100 in such a way that the initiator ensures that the data is received at the first target 308 and the second target 310.

In an embodiment the discovery domain 300 is the only discovery domain on the information storage network 100, and the initiator 302 can send more data streams than the information storage network may be able process at the same time. In such a situation, the initiator 302 leverages or sets priority bits in the headers of the data streams sent through the information storage network 100, which allows the most important data streams to pass through the information storage network before other data streams. In an embodiment the discovery domain 300 may be one of several discovery domains on the information storage network 100, whereby the priority of the data streams sent by the initiator 302 is compared with other data stream priorities from other initiators in the information storage network 100. When the information storage network 100 processes the data streams sent to the first target 308 and the second target 310, the information storage network looks at the priority bits (set by the initiator 302) of the data streams to determine which data streams to send and which data stream to queue in the information storage network before being sent.

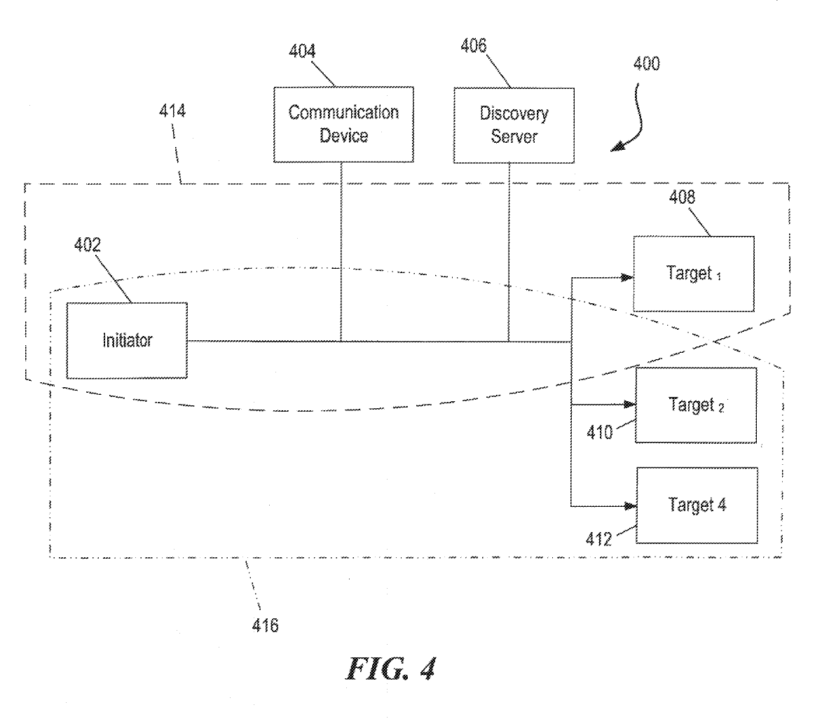

FIG. 4 shows a block diagram of an exemplary embodiment of an information storage network 400 comprising an initiator 402, a communication device 404, a discovery server 406, a first target 408, a second target 410, and a third target 412. In this embodiment the initiator 402 has discovery domains 414 and 416 that it is given access to by the discovery server 406. Additionally, the initiator 402 uses the communication device 404 to register with and request target information from the discovery server 406. In an embodiment the discovery server 406 returns to the initiator 402 the targets that are in the discovery domain on the initiator. In an embodiment the discovery server 406 returns to the initiator 402 that the target 408 is in the first discovery domain 414 of the initiator and that the second target 410 and the third target 412 are in the second discovery domain 416 of the initiator. Then the initiator 402 receives priority information, such as QoS, about the first target 408, the second target 410, and the third target 412 from the policy engine (not shown) of the discovery server 406. In an exemplar embodiment the priority information for the first target 408, the second target 410, and the third target 412 is set on the targets themselves, or an administrator sets the priority information for both targets directly into the policy engine of the discovery server 406. This priority information helps the initiator 402 send the data over the information storage network 400 in such a way that the initiator ensures that the data is received at the first target 408, the second target 410, and the third target 412.

In an embodiment the initiator 402 can send data streams to any one of the first target 408, the second target 410, and the third target 412 even though the targets are in different discovery domains because all of the targets are in a discovery domain accessible by the initiator 402. In this embodiment the initiator 402 may send more data streams than the information storage network 400 may be able process at the same time. In such a situation, the initiator 402 leverages or sets priority bits in the headers of the data streams sent through the information storage network 400, which allows the most important data streams to pass through the information storage network before the other data streams. When the information storage network 400 processes the data streams sent to the first target 408, the second target 410, and the third target 412 the information storage network will look at the priority bits (set by the initiator 402) of the data streams to determine which data streams to send and which data streams to queue in the information storage network.

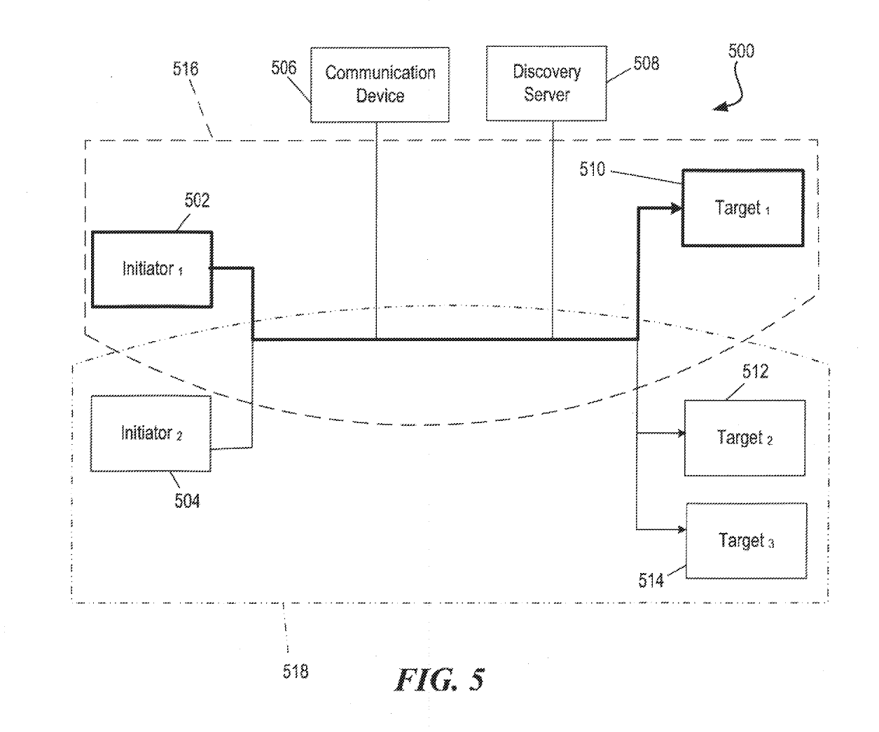

FIG. 5 shows a block diagram of an exemplary embodiment of an information storage network 500 comprising a first initiator 502, a second initiator 504, a communication device 506, a discovery server 508, a first target 510, a second target 512, and a third target 514. In an embodiment the first initiator 502 and the first target 510 are part of a first discovery domain 516. Additionally, the second initiator 504, the second target 512, and the third target 514 are part of a second discovery domain 518. In an embodiment the first initiator 502 and the second initiator 504 use the communication device 506 to register with and request target information from the discovery server 508. The discovery server 508 returns to the first initiator 502 and the second initiator 504 the targets that are in the discovery domains of each initiator. In the information storage network 500 embodiment, the discovery server 508 returns to the first initiator 502 that the target 510 is in the first discovery domain 516 of the first initiator. Also, the discovery server 508 returns to the second initiator 504 that the second target 512 and the third target 514 are in the second discovery domain 518 of the second initiator. Then the first initiator 502 and the second initiator 504 receive priority information, such as QoS, about the first target 510, and the second target 512 and the third target 514 respectively from the policy engine (not shown) of the discovery server 508.

In an embodiment the priority information for the first target 510, the second target 512, and the third target 514 is set on the targets themselves, or an administrator sets the priority information for all the targets directly into the policy engine of the discovery server 508. This priority information helps the first initiator 502 send data over the first discovery domain 516 of the information storage network 500 in such a way that the first initiator ensures that the data is received at the first target 510. This information also helps the second initiator 504 send data over the second discovery domain 518 of the information storage network 500 in such a way that the second initiator ensures that the data is received at the second target 512 and the third target 514. In this embodiment the first initiator 502 and the second initiator 504 may send more data streams than the information storage network 500 may be able process at the same time. In such a situation, the first initiator 502 and the second initiator 504 leverage or set priority bits in the headers of the data streams sent through the information storage network 500, which allows the most important data streams to pass through the information storage network before the other data streams. When the information storage network 500 processes the data streams sent to the first target 510, the second target 512, and the third target 514 the information storage network will look at the priority bits (set by the first initiator 502 and the second initiator 504) of the data streams to determine which data streams to send and which data to queue in the information storage network before being sent.

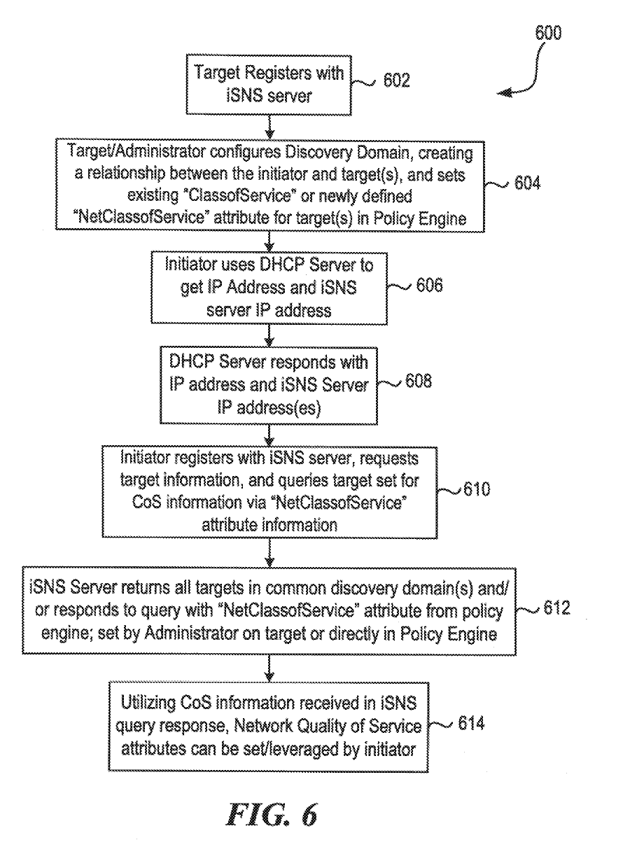

FIG. 6 shows a flow diagram 600 of an exemplary method for storing data on an information storage network. Through the steps of the flow diagram 600 data is sent based on the priority of the data to make sure that the most important data sent to a target for storage is actually received when it should. In an exemplary embodiment a target first registers with an Internet Storage Name Service (iSNS) server, as shown in step 602. Next, in step 604 either the target or an Administrator configures a Discovery Domain in the information storage network. The configuration of a Discovery Domain creates a relationship between an initiator and a target or multiple targets. Also, in step 604 either the target or an Administrator sets an existing “ClassofService” (CoS) or a newly defined “NetClassofService” attribute for the target or targets of the Discovery Domain in the Policy Engine. The Policy Engine is the part of the iSNS server that allows the initiator to access information about the target or targets. Then, in step 606 an initiator uses a Dynamic Host Configuration Protocol (DHCP) server to get an Internet Protocol (IP) Address and the iSNS server's IP address. Additionally, in step 608 the DHCP server responds with an IP address for the initiator and the IP address or addresses for the iSNS server. In getting the IP addresses for the initiator and the iSNS server, the initiator now has access to and can find the iSNS server over the information storage network. In step 610, the initiator registers with the iSNS server, and during this process the initiator requests the target information and queries the target set CoS information via “NetClassofService” attribute information. Next, in step 612 the iSNS server returns all of the targets that are in a common discovery domain or in multiple discovery domains that the initiator can access. Also the iSNS server responds to the query with the “NetClassofService” attribute from the policy engine in the iSNS. An administrator sets the “NetClassofService” attribute in the policy engine by either the target or directly into the policy engine. Finally, in step 614 the initiator sets or leverage the Network Quality of Service attributes to utilize the CoS information received by the initiator in the iSNS server's response to the query made by the initiator.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method for applying quality of service in a storage network, the method comprising:
registering at least one target with a server;
setting a quality of service priority for the target on the server, on the target, or on both the server and the target;
registering at least one initiator with the server; and
utilizing the quality of service priority in the initiator to send data to the target.

2. The method claim 1 further comprising:
requesting information about the target from the server for the initiator; and
receiving information about the target from the server on the initiator.

3. The method of claim 2 further comprising:
linking the initiator with the target;
sending the data to the target;
processing the data based on the quality of service priority sent from the initiator; and
receiving data from the initiator on the target.

4. The method of claim 3 wherein the quality of service priority is stored in a policy engine of the server.

5. The method of claim 3 wherein the initiator bases the quality of service priority for the data on the target the data is sent.

6. The method of claim 3 wherein the information about the target comprises one of a location, a quality of service, and any combination thereof.

7. A storage network comprising:
a first server;
a second server;
at least one target having a quality of service priority set on the target, on the second server, or on both the target and the second server; and
at least one initiator utilizing the quality of service priority in sending data for storage on the target, the initiator being connected to the target, the first server and the second server.

8. The storage network of claim 7 wherein the target registers with the first server.

9. The storage network of claim 8 wherein the initiator uses the first server to register with the second server.

10. The storage network of claim 9 wherein the target supplies the second server with quality of service priority for the target.

11. The storage network of claim 10 wherein the initiator receives the quality of service priority about the target from the second server.

12. The storage network of claim 11 wherein the initiator sends data to the target using the quality of service priority.

13. The storage network of claim 9 wherein the quality of service priority for the target is set on the second server.

14. The storage network of claim 13 wherein the initiator receives the quality of service priority about the target from the second server.

15. The storage network of claim 14 wherein the initiator sends data to the target using the quality of service priority.

16. A method for sending data in a storage network, the method comprising:
sending multiple data streams simultaneously over a network;
setting a priority for the data streams; and
utilizing the priority of the data streams in at least one initiator to ensure the receipt of the data streams.

17. The method of claim 16 wherein a server, at least one target, or both the server and the target sets the priority of the data streams as a quality of service.

18. The method of claim 17 wherein the initiator receives the quality of service from the server, the target, or both the server and the target.

19. The method of claim 18 wherein the initiator leverages the quality of service to establish the priority the data streams.

20. The method of claim 19 wherein the initiator sends the priority data streams to the target.
